(19) United States
(12) Patent Application Publication
(10) Pub. No.: US 2026/0320201 A1
(43) Pub. Date: Oct. 15, 2026

(54) DATA MANAGEMENT SYSTEM AND METHOD OF VALIDATING AN IDENTITY

(71) Applicant: Sandgrain B.V., Eindhoven (NL)

(72) Inventors: Pieter Werner HOOIJMANS, Eindhoven (NL); Jeroen Mathias DOUMEN, Eindhoven (NL); Casparus Anthonius Henricus JUFFERMANS, Eindhoven (NL)

(21) Appl. No.: 19/476,207

(22) PCT Filed: Apr. 18, 2024
(86) PCT No.: PCT/IB2024/053770

§ 371 Date: Oct. 17, 2025

(30) Foreign Application Priority Data
Apr. 18, 2023 (NL) 2034621

(51) Int. Cl. G06F 21/60

(52) U.S. Cl. CPC G06F 21/602

(57) ABSTRACT

A data management system for managing data relating to assets, arranged in one or more groups, comprising a first data storage comprising an asset database storing an asset identifier for each asset, and a second data storage adapted to store a group code and a cryptographic key for each group of assets. The first data storage (31) additionally stores status information (ASI) associated with each asset (2), and wherein the verification module (7) is adapted to access the status information (ASI) associated with the first asset (2) from the first data storage (31) if the first asset identifier (AID) matches an asset identifier (AID) stored in the first data storage (31), and generate a verification result (V) based at least in part on the accessed status information (ASI).

### TECHNICAL FIELD

The present invention relates to an asset data management system and a method of managing data for a plurality of managed assets.

### BACKGROUND ART

Over the last three decades, integrated circuit (IC)-based identification and security-based technologies and associated devices have reached a broad set of applications. Well-known examples are public transport ticketing, smart card conditional access systems for TV subscriptions, SIM cards in mobile phones, electronic passports, banking or credit cards, and labeling for tracking and managing logistic flows and transport. Volumes associated with these applications run in the billions of ICs per year. However, there are potentially many more applications that could use these technologies, that could further multiply these volumes by several orders of magnitude, so indeed hundreds of billions or trillions of IC's. So far this is not happening for two fundamental reasons: security and cost.

A main problem in the world of identification and security is hacking. Existing identification and security applications are typically built around so-called secure microcontrollers. Microcontroller units (MCU) are required for functions like authentication or security key generation, and storing of the relevant data in such a way that it is not accessible for intruders. Because MCUs typically operate under an operating system and a specific program, e.g. firmware program, to execute the required functions, they are typically a combined hardware (HW) and software (SW) solution.

Known systems have as a major drawback that they can be hacked. This in practice means reverse engineering the function of the device by analyzing its HW and/or SW behavior, resulting in the discovery of e.g. a secret (cryptographic) key as typically required in these known systems and stored in a memory. In a worst-case scenario, the memory content of the device is altered, e.g. by increasing the amount of credits on a transit card or changing the balance on a bank card. Although suppliers of these ICs and systems implement measures to make their ICs robust to hacking, in the end most systems are vulnerable and can be hacked, albeit at often high technological effort.

The other problem with existing security solutions is related to cost. With high-volume applications of IC related security solutions, an obvious requirement is to have the IC cost as low as possible. Today's ICs typically cost a few dollar cents, which multiplies by a factor four for the final assembled module or package sales price. Elements that increase the IC cost are the MCU infrastructure and the programmable on-chip memories. Typical elements that increase the IC cost are:
Secure MCUs are expensive, either as in-house development or as purchased IP, e.g. as ARM™ Secure Cores;
MCUs are complex functions, and although the core is relatively small in advanced technology, it requires all kind of peripheral functionality to make it work properly: communication busses, memories (usually a combination of multiple specific memories, like RAM, ROM, Flash), start-on and advanced power management circuitry. So, the total function is much bigger, and requires serious design effort;
The simplest identification products don't require re-programmable memories or keys. But even so, during manufacturing of the IC the code needs somehow be written in its memory. In most cases thus is done using One Time Programmable Read Only Memories (OTP-ROM), but these IP blocks are big, and require high voltage supply, making them large and thus expensive;
More complex identification and security ICs have programmable key or data storage, which requires re-programmable Non-Volatile Memory (NVM), often also referred to as flash memory. But flash memories are expensive technology features, requiring—depending upon the size of the baseline CMOS node—10 to 12 additional mask layers in production. This can be a cost adder of typically 35 to 30% compared to non-flash baseline technology wafer cost;
Identification and security ICs have a complex Back End (BE) process in the assembly and packaging fab, since every ICs requires pre-programming with its secure SW and—in case of non-programmable ICs—the embedded keys or identifiers.

With high volumes of IC's there is a need for a cost effective yet secure solution for applying identification codes to the IC's. Moreover, the identification codes should be very-fiable, e.g. as proposed by earlier publication WO2021240445, and a need exists for smartly structured server for securely dealing with such IC comprising end nodes of a secure system

### BRIEF SUMMARY OF THE INVENTION

The present invention aims to provide a centralized solution for managing and verifying identification codes of integrated circuits (IC's). The present invention is particularly useful with, but not limited to, large number of IC's each having a unique identification.

The present invention enables identification and security solutions that are much cheaper at the high-volume customer or user end of the chain, and shift complex security functionality away from those end nodes.

According to an aspect of the invention, a data management system is provided for managing data relating to assets, the assets arranged in one or more groups of assets. The system comprises a first data storage comprising an asset database storing an asset identifier for each asset, and a second data storage adapted to store a group code and a cryptographic key for each group of assets. The system further comprises a receiving module adapted to receive a group code and an asset code from a first asset, a cryptographic module communicatively coupled to the receiving module and the second data storage, and adapted to derive a first asset identifier corresponding to the asset code received from the first asset, using a cryptographic key obtained from the second data storage, the cryptographic key associated with the group code received from the first asset, and a verification module communicatively coupled to the cryptographic module and the first data storage, and adapted to verify the status of the first asset, wherein the verification module is adapted to determine if the first asset identifier matches an asset identifier stored in the first data storage and generate a verification result based at least in part on the determination, wherein the data management system stores a set of asset identifiers for identifying the assets in the first data storage, whereas a group code and an asset code is stored in each asset. The asset identifiers are not stored in the assets, and the asset codes are not stored in the data management system. The group codes and group cryptographic keys are stored in the second data storage, and these provide the (only) link between the asset codes stored in the assets and asset identifiers stored in the data management system. In this way, gaining access to the information stored in the first data storage (but not the information stored in the second data storage) does not provide any information that can be related to any specific assets. Furthermore, gaining access to the information stored in an asset (but not the information stored in the second data storage) does not provide any information that can be related to the asset information stored in the first data storage.

The information stored in the second data storage enables the data management system to perform its functions. When an asset is placed in communication with the system, and the group code and asset code from the asset is transmitted to the system, then a cryptographic module in the system derives the corresponding asset identifier for the asset, using a cryptographic key associated with the group code from the first asset. This enables the system to relate the asset code of the asset to the corresponding asset identifier stored in the first data storage. A verification module in the system can then ascertain whether the derived asset identifier (derived from the received asset code) matches one of the asset identifiers stored in the first data storage.

If there is no match, then the system may generate a negative verification result. This may occur, for example, if a fake asset code is transmitted to the system. If there is a match, then the system may generate a positive verification result, subject to any other criteria also applied by the system. This result may be used, for example, in a procedure to confirm the identity or authenticity of the asset, or enable access to restricted information or services by the asset.

As an unexpected and unique feature of the presently proposed secure system, the first data storage additionally stores status information associated with each asset, and wherein the verification module is adapted to access the status information associated with the first asset from the first data storage if the first asset identifier matches an asset identifier stored in the first data storage, and generate a verification result based at least in part on the accessed status information.

In this way, additional information about the assets may be stored in the system, where the status information is only linked to the assets and asset codes by the information stored in the second data storage. Uniquely, while it might in general or in hindsight not be considered anything peculiar to record status information in some system systems, e.g. with historical track record, it has never been demonstrated, nor considered to not only store such information in the context of identification as in the here claimed secure system, but also use such information to influence a decision concerning identity. The status information may be used in part to determine the verification result. For example, the status information may indicate whether the asset is activated or deactivated, active or suspended, blocked or not blocked, etc. For example, if an asset is indicated as being deactivated, suspended, or blocked, then the verification module may be configured to generate a negative verification result for the asset.

In an embodiment, the system further comprises a database update module communicatively coupled to the receiving module and the first data storage, and adapted to generate contextual data associated with each asset, wherein the contextual data comprises data relating to current and previous receipts of a first group code and/or a first asset code by the receiving module, including one or more of: a total number of the receipts, a number of the receipts in a predefined time period, a frequency of the receipts, times of the receipts, and/or a location from where the receipts originate. In this way, the update module can be arranged to create and update contextual information for an asset based on activity relating to the asset. The contextual information can provide an indication that an asset or asset code has been compromised, for example by cloning or copying the asset code, or whether the asset or asset code is being misused.

In an embodiment, the first data storage is adapted to store the contextual data associated with each asset, and wherein the verification module is adapted to access the contextual data associated with the first asset from the first data storage if the first asset identifier matches an asset identifier stored in the first data storage, and generate a verification result based at least in part on the accessed contextual data. The contextual data may be included in the status information for an asset, and/or stored along with the status information in the first data storage. The update module may create or update the status information for an asset on the basis of the contextual information for that asset, for example changing the status information for an asset to indicate a blocked status if the contextual data indicates that the asset has been compromised or misused.

In an embodiment, the first asset is adapted to transmit the group code and asset code to the receiving module, and the system further comprises a transmitting module adapted to transmit the verification result to the first asset. For example, the asset may communicate directly with the data management system.

In an embodiment, the system further comprises a asset terminal, wherein the terminal is adapted to receive the group code and asset code from the first asset, and transmit the received group code and asset code to the receiving module, and the system further comprises a transmitting module adapted to transmit the verification result to the terminal. For example, a terminal may be used for communication with the data management system. In this way, the asset may communicate with the terminal (and the asset may not be equipped to communicate with the data management system), and the terminal is adapted to verify the identity and/or authenticity of the asset by communicating with the data management system.

In an embodiment, the first data storage comprises a plurality of separate data storage devices. The number of assets may be (very) large and the quantity of asset data also large, and it may be desirable to provide a (large) number of separate storage devices which together comprise the first data storage,

In an embodiment, the second data storage is a secure data storage adapted to limit access to the stored data using a security protocol. The information stored in the second data storage enables the data management system to relate the asset code of the asset to the corresponding asset identifier stored in the first data storage. Without access to the second data storage, the asset codes stored in the assets cannot be linked to the asset identifiers stored in the data management system. In view of this, access to the second data storage is restricted using a secure access system, for example using passcodes, cryptographic keys, biometric security and/or other suitable means.

In an embodiment, the database of the first data storage is adapted to store the group codes, or these may be stored only in the second data storage.

In an embodiment, the system further comprises a generation module communicatively coupled to the first data storage, and adapted to generate an asset code corresponding to an asset identifier using a cryptographic key associated with the group code of the corresponding asset identifier. This enables starting from a set of asset identifiers (to be stored in the first data storage) and generating corresponding asset codes to be stored in the assets. The generation module preferably uses the same cryptographic key used by the cryptographic module, which is preferably stored in the second data storage. The cryptographic operation performed by the generation module is preferably the reverse of that performed by the cryptographic module, i.e. the cryptographic module derives an asset identifier corresponding to an asset code, while the generation module derives an asset code corresponding to an asset identifier. The cryptographic module may be adapted to perform both of these functions, and the generation module may then utilize the cryptographic module to derive the asset codes.

Alternatively, the generation module may be adapted to generate an asset identifier corresponding to an asset code using a cryptographic key associated with the group code of the corresponding asset code. This enables starting from a set of asset codes (to be stored in the assets) and generating corresponding asset identifiers to be stored in the first data storage. The generation module may then utilize the cryptographic module to perform this function.

In an embodiment, the asset comprises an integrated circuit having an asset code of the asset permanently hard-coded into the integrated circuit, or the asset may comprise an integrated circuit having both a group code and an asset code of the asset permanently hard-coded into the integrated circuit. In this way, the asset code and/or group code can be stored in the asset is permanent way so it cannot be changed. The functionality of the integrated circuit may be limited to providing the asset code upon request, or limited to providing both the group code and the asset code upon request. In this way, the functionality of the IC storing the codes may be kept to a minimum to reduce the cost of the IC to a minimum, enabling extremely low cost tagging of assets to allow their use with the data management system.

In an embodiment, the cryptographic module is adapted to generate a second cryptographic key associated with one of the groups, the second data storage is adapted to store the second cryptographic key, and the system is adapted to use the second cryptographic key to authenticate communications between the asset and the transmitting and receiving modules, or between a terminal and the transmitting and receiving modules (where the terminal communicates with the asset).

In an embodiment, the asset comprises an integrated circuit having a group code, an asset code, and an authentication value of the asset permanently hard-coded into the integrated circuit, wherein the authentication value is generated based on the second operator key.

In an embodiment, the functionality of the integrated circuit is limited to providing the group code, the asset code, and the authentication value upon request, and receiving a challenge message from the transmitting module and transmitting a response based on the authentication value.

In another aspect of the invention, a method is provided for managing data relating to assets, the assets arranged in one or more groups of assets, the method comprising: assigning a group code to each group of assets; generating an encryption key linked to the group code; storing the group code and the encryption key in a second data storage; assigning an asset identifier to each asset in the group; storing the group codes and the asset identifiers in a database in a first data storage; receiving a group code and an asset code from a first asset; deriving a first asset identifier corresponding to the asset code received from the first asset, using a cryptographic key associated with the group code received from the first asset; verifying the status of the first asset, comprising determining if the first asset identifier matches an asset identifier stored in the first data storage; and generating a verification result based at least in part on the determination.

In an embodiment, the method further comprises storing status information associated with each asset in the first data storage, wherein verifying the status of the first asset comprises accessing the status information associated with the first asset from the first data storage if the first asset identifier matches an asset identifier stored in the first data storage, and the verification result is based at least in part on the accessed status information.

In an embodiment, the method further comprises generating an asset code corresponding to an asset identifier using a cryptographic key associated with the group code of the corresponding asset identifier, and storing the generated group code and asset code in the asset corresponding asset identifier.

Thus, the data management system provides a database of asset information which is secured by anonymizing the information, i.e. the asset identifiers stored in the data management system cannot be linked to the asset codes stored in the assets, without access to the information stored in the second data storage. Thus, hacking into the first data storage of the data management system does not provide useful information, unless access can also be gained to the information in the second data storage. Furthermore, obtaining the asset code from an asset does not provide useful information either. Asset codes cannot be linked to the asset information in the data management system, unless access can also be gained to the information in the second data storage. Furthermore, the data management system may be configured to detect anomalous use of asset codes and block future attempts to use fake or copied asset codes.

Thus, the problem of securing large volumes of asset data stored in the first data storage is reduced to securing a much smaller volume of data in the second data storage, and access to the second data storage may be restricted using known security protocols and methods such as passcodes, cryptographic keys, biometric security and/or other suitable means. This greatly reduces the security problem.

The requirement to employ complex security technology in the assets is removed.

This reduces the cost and complexity of the assets, for example the assets may be provided with a very simple and cheap integrated circuit which contains the group code and asset code. Since there may be a (very) large number of assets to be managed by the system, this results in significant benefits.

The requirement to employ complex security technology in the first data storage is also removed, reducing the cost and complexity of the first data storage. The number of assets may be (very) large and as a consequence the quantity of asset data also large. It may be desirable to provide a (large) number of separate storage devices which together comprise the first data storage, to accommodate a large amount of data and/or to accommodate separate customers of the system who each have their own asset database. This, reducing the security requirements in the first data storage also results in significant benefits.

The data management system is scalable over orders of magnitude, from tens to billions of assets, making it possible to monitor and track huge numbers of even low-value assets. The requirements imposed on the assets is minimal, and can be limited to storing a group code and asset code and providing them on request, so that the additional cost in the asset is very low and allowing deployment in very large numbers. For example, tagging individual products with a group code and asset code becomes feasible, such as tagging components involved in complex logistics chains (e.g. components for aircraft or car assembly), as well as lower value consumer products such as batteries, light bulbs, or even supermarket products.

Customers of the asset data management system can choose at which level they want to code and track their products. e.g. high turn-over goods such as food could be coded by production batches with codes that have a time-limited validity. The asset codes can, if desired, be different at individual product level. The assets can be tracked at every interaction with the data management system, enabling “big data” analysis and possible interaction with the asset.

The data management system may be distributed among multiple servers or multiple networked computers while functioning as a single system, and may be implemented wholly or partly as a cloud service.

Aspects and embodiments of the invention are further described in the following description of example embodiments and in the claims.

### BRIEF DESCRIPTION OF THE DRAWINGS

The features and advantages of the invention will be appreciated upon reference to the following example embodiments, described by way of example only, with reference to the accompanying schematic drawings in which corresponding reference symbols indicate corresponding parts, and in which:

FIG. 1 shows an exemplary data storage configuration in an asset data management system according to an aspect of the invention;

FIG. 2 shows another exemplary data storage configuration in an asset data management system according to an aspect of the invention;

FIG. 3 shows another exemplary data storage configuration in an asset data management system according to an aspect of the invention;

FIG. 4 shows a schematic representation of an exemplary integrated circuit of an asset according to an aspect of the invention;

FIG. 5 shows an exemplary integrated circuit of an asset according to an aspect of the invention;

FIG. 6 shows an exemplary flow chart of a method of storing asset data in an asset according to an aspect of the invention;

FIG. 7 shows an exemplary flow chart of a method of generating asset status data according to an aspect of the invention;

FIG. 8 shows an exemplary flow chart of a method of handling asset data according to an aspect of the invention; and

FIG. 9 shows an exemplary architecture of an asset data management system according to an aspect of the invention.

The figures are intended for illustrative purposes only, and do not serve as restriction of the scope or the protection as laid down by the claims.

### DESCRIPTION OF EMBODIMENTS

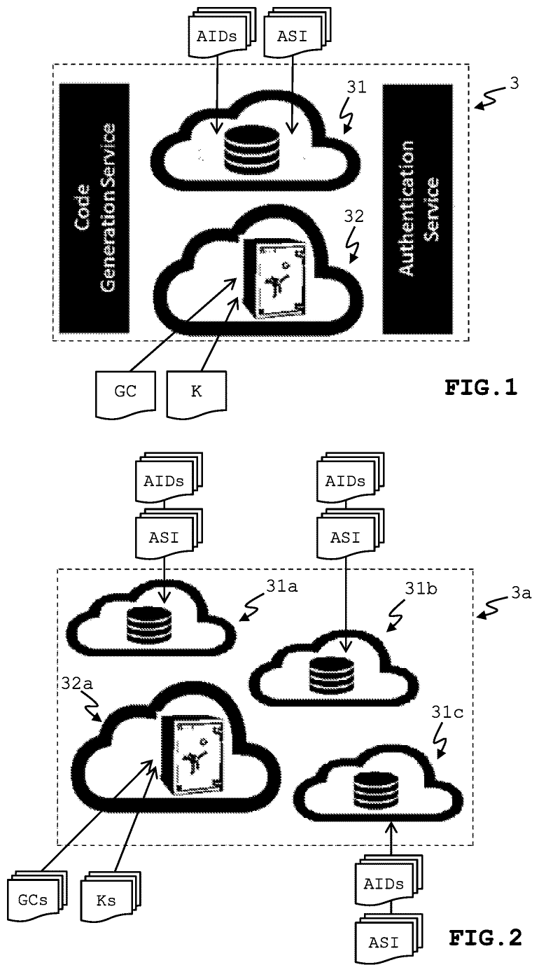

FIG. 1 shows an exemplary asset data management system 3, comprising a first data storage 31 and a second data storage 32. The data storages are typically implemented as databases, stored on one or more servers. The asset data management system 3 may be implemented wholly or partly as a cloud service, and may operate as a centralized code registration system for managing data for a plurality of assets 2. The assets 2 may be anything which a customer or owner of the data management system wants to track or manage or collect data from. The assets may be complex higher value products such as a television or aircraft component, or may be a lower value product such as a credit card, battery, light bulb, or food product.

The first data storage 31 stores asset identifiers AID of a plurality of assets 2, and may also store asset status information ASI for each of the assets. The second data storage 32 stores one or more cryptographic keys K used for managing the asset data.

A mathematical operation performed in the system 3 may generate an asset code CID from an asset identifier AID using an cryptographic key K, and vice versa. Assets codes are stored in the assets and may thus be verified against asset identifiers AIDs stored in the first data storage 31. Herein, the mathematical operation may be a look-up table operation.

The assets may be divided into groups, each group having a group code GC assigned to it, and a cryptographic key K may be associated with a group code GC. This allows asset identifiers AIDs to be reused for different groups of assets, by applying different keys K depending on the group code GC.

The first data storage 31 need not be highly secured. In fact, the asset identifiers AIDs cannot be linked to an asset, i.e. to an asset code CID, without having access to the mathematical operation and/or the cryptographic keys Ks. The second data storage 32 and the mathematical operation are preferably secured, e.g. using cryptographic data storage, secured communication protocols, and/or secure execution environments.

The data management system 3 may include an authentication service, enabling an authentication request for an asset to be received and processed. The asset code CID of an asset may then be received by the data management system and verified against the stored asset identifiers AIDs, using the mathematical operation to obtain the asset identifier corresponding to the asset code.

The data management system 3 may include an asset code generation service, enabling asset identifiers AIDs and corresponding asset codes CIDs to be generated and prepared for implementing in the assets. The assets codes maybe hard-coded into a chip as a chip identifier CID. The data management system 3 may provide for the generation of GDSII files for use by an chip manufacturing foundry, where the asset codes CID may be written into a read only memory of a series of chips to be included in the asset.

Thus, metadata related to an asset 2 may be separated from the asset code CID. A user of the data management system 3 may see an asset code CID, without knowing to which asset record, i.e. which asset identifier AID this asset code CID belongs. The two can preferably only be connected via and by the data stored in the second data storage 32, e.g. a second secure database, effectively constituting a vault as it were. Rather than revealing the relation between the asset codes CID in the assets and the asset identifiers AID stored in the first data storage 31, the secure database or vault 32 may instead only output a verification result, e.g. in the form of a ‘yes’ or a ‘no’. In this manner neither the asset owner, or the operator of the secure database, or the operator of the verifying functionality, will ever become aware which asset code CID belongs to which asset identifier AID as long as the two are maintained separate and the secure database is effectively maintained secure in a manner known per se.

The effect of the use of two separate data storages 31, 32, e.g. two separate databases, with the second data storage 32 being secure, is not only that asset holders may effectively and relatively economically rely on a centralized data management service for asset tracking and authentication and asset information management. With such a system and method of managing asset data, the required security functionality may attractively be shifted from the assets to a minimal part of a centralized system, i.e. the second data storage, implying that neither security measures nor security costs need to be distributed over each of the assets or over each of the storage devices comprising the first data storage 31. Rather, the assets in such a system are simply provided with an unchangeable asset code, e.g. through hard-coding the asset code in a chip in or on the asset. The asset code may be a simple electronically readable code, and may even lack any facilities to restrict reading of the asset code.

A data management system 3a may store asset identifiers AIDs and asset status information ASI for different groups of assets assigned different group codes GC. An example hereof is shown in FIG. 2, where first data storage 31a, first data storage 31b, and first data storage 31c are each similar to first data storage 31 and each store asset identifiers AIDs for different group codes GCs. In the example of FIG. 2 the group codes GC for all of the first data storages 31a, 31b, 31c are stored associated with the cryptographic keys K for each group in the second data storage 32a.

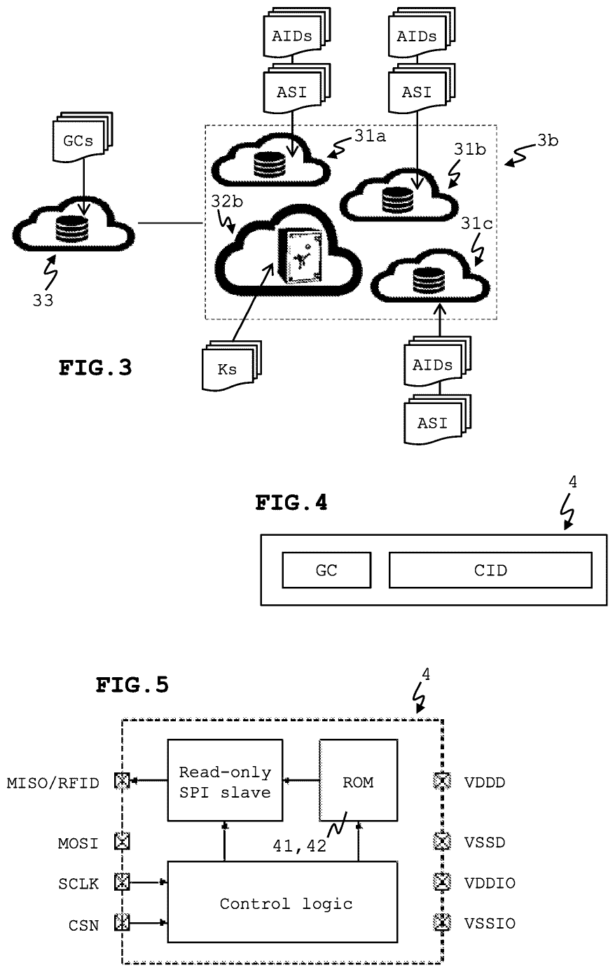

The group codes GCs may alternatively be stored in a separate database 33, such as shown in FIG. 3. The group codes GCs in the separate database 33 and the cryptographic keys K stored in second data storage 32b may be associated using known database structures, e.g. using database links or any other data structure. The separate database 33 may be part of or external to a data management system 3b.

FIG. 4 is an abstract representation of an integrated circuit 4 included in each asset, wherein a group code GC and an asset code CID have been stored in a memory, typically a read-only memory in the IC 4. The asset code CID is preferably unique amongst all assets for a same group code GC, but it is possible to use the same asset code in different assets for a same group code if desired. Asset codes CID may be reused for assets in different group codes GC.

FIG. 5 shows an exemplary integrated circuit 4. The IC 4 may include one or more ROM registers 41, 42, e.g. a 32-bit (4×8) ROM 41 embedding a 32-bit group code GC and a 128-bit (16×8) ROM 42 embedding a 128-bit asset code CID. The IC 4 may include an interface, here embodied in the form of a Serial Peripheral Interface (SPI) and control logic for outputting the identifier on a request received via the Control logic. The IC 4 may include voltage inputs, such as VDDD, VSSD, VDDIO and VSSIO. The IC 4 may further include signal inputs, such as MOSI (Master Output Slave Input), SCLK (Serial CloCK) and CSN (Chip Select Not). The IC 4 may further include a signal output, such as MISO (Master Input Slave Output) or any other output such as an RFID output.

It will be understood that the IC 4 is not limited to having SPI-based interfaces. Other non-limiting examples of interfaces that may be used in the IC 4 are serial interface like I2C or I2S, 3-wire, 1-wire, USB or a classical 13,56 MHz RF-ID contactless interface.

Moreover, it will be understood that the IC 4 is not limited to 4×8 and 16×8 ROM registers and that any other read-only register may be used for storing a group code GC and asset code CID of any bit length. It is possible to store the group code GC and the asset code CID in a single memory, e.g. a single ROM of 160 bits.

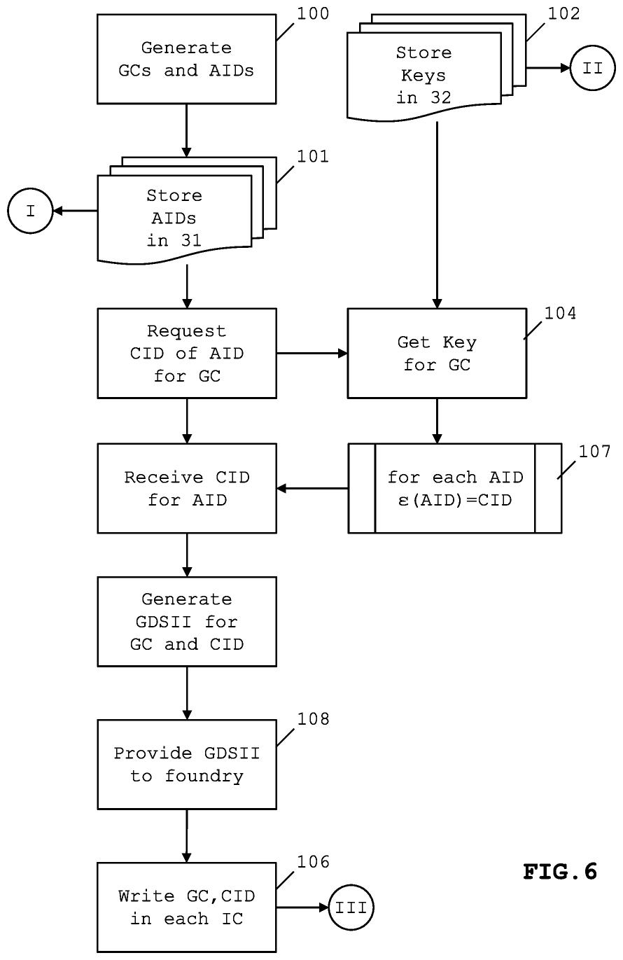

In FIG. 6 a flow chart is shown of an exemplary method performed in the data management system 3, 3a, 3b for generating asset identifiers AID and implementing the corresponding asset codes CID in the assets. The steps in the left column of FIG. 6 may be performed in a less secure part of the data management system 3. The steps in the right column of FIG. 6 are preferably performed in a secured part of the data management system.

In step 100 one or more asset identifiers AID are generated. This is typically the first time that the asset identifiers AID are generated for a specific group code GC. In step 101 the asset identifiers AID are stored in the first data storage 31. The asset identifiers AID may be used later when verifying the authenticity of assets based on the asset code of the asset, which is depicted by the roman numeral I (see also FIG. 8).

For the generated asset identifier AID, an asset code CID to be stored in the asset is to be generated. Hereto the asset code is requested and in step 104 the cryptographic key K associated with the group code GC is obtained from the second data storage 32. One or more cryptographic keys K for the group code GC may have been generated and stored in step 102. The cryptographic keys K may be used later when verifying the identity or authenticity of assets based on the asset code CID of the asset, which is depicted by the roman numeral II (see also FIG. 8).

In step 107 a mathematical operation ε may be performed on the asset identifier AID to obtain the asset code CID. This is depicted as ε(AID)=ID. The mathematical operation may use the cryptographic key K, for example as a cryptographic encryption key in an AES-based cryptographic mathematical operation.

The thus obtained asset code CID and the group code GC may be provided to an IC manufacturing foundry. Hereto the asset codes CID may be received. This receipt may be at another place than the place of request, e.g. a secure box at a lithographic machine producing a chip. There may be an interruption in the linking process by request to and operation of a second database in the right-hand side column.

For example, a GDSII file may be generated based on the asset code CID and the group code GC, which GDSII file may be provided to the foundry in step 108. In step 106 the GDSII file, or any other data file enabling the foundry to create the IC, may be used to write the asset code CID and the group code GC to a memory portion of an IC being formed on a wafer.

The asset code CID and group code GC stored in the asset 4 may be used later when verifying the authenticity of assets, which is depicted by the roman numeral III (see also FIG. 8).

In an embodiment, to generate a per-chip unique—e.g. 128-bit—asset code CID, an intermediate encoding may be used. First, every user of the data management system (also referred to as a customer or operator) that desires to encode or tag assets for use with the system, may receive a unique and secret cryptographic key K, e.g. a 128-bit or any other bit length key. The cryptographic key K is preferably kept in a secure location such as the second data storage 32, for example in a central software vault processing center (e.g. HSM) of the data management system 3. All computations that require encoding or decoding with this cryptographic key K preferably only take place within this central vault. If now a series of n assets require an asset code, a list of n numbers may be generated, in its most simple form just the list 1, 2, . . . , n-1, n. These numbers may be or represent the asset identifiers AIDs to be stored in the first data storage 31. This list may be passed to a vault processing unit, which encodes or encrypts these n numbers using the mathematical operation based on the cryptographic key K. This preferably happens inside the vault, and preferably only the list of asset codes CID thus obtained is received as output from the vault. The obtained asset codes, e.g. CID1, CID2, . . . , CIDn of 128 bits each, or any other length, may then be processed into a GDSII file describing the layer structure of ICs on a wafer, and transmitted to a mid-end fab and written on the n assets.

Although stealing (essentially copying or cloning) of such a series of asset codes CID doesn't provide any advantage to a hacker, it would be annoying and therefore the transmission of the n asset codes CID from the vault to the IC fab may be secured using e.g. standard AES encryption techniques.

Instead of every asset being coded individually, a user may e.g. decide to code groups of assets with the same asset code CID per batch, per production day, per production location, etc. Of course, this reduces the asset identification level to such a group, but for fast turnover products (e.g. fresh food) this might be more than enough.

Once produced the integrated circuits 4 carrying their, possibly unique, asset code CID, may be physically attached to or incorporated into the asset they are intended to identify. The asset may be, for example, a bank note, another IC in a multi-chip package, a PCB board, a module or complete device or machine, etc. At any moment the asset code CID of the asset can be read, using the interface provided by the asset.

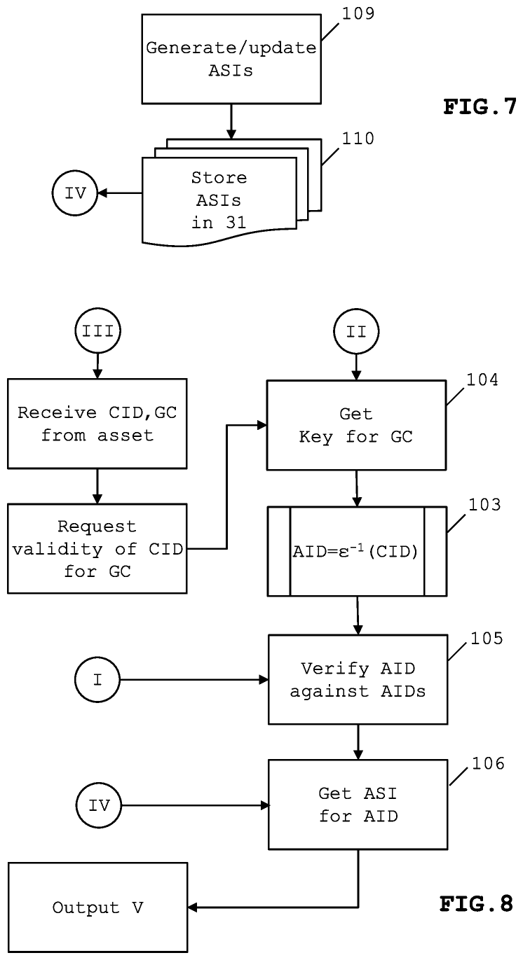

In FIG. 7 a flow chart is shown of an exemplary method performed in a data management system 3, 3a, 3b for generating, updating, and storing asset status information ASI. The steps in FIG. 7 may be performed in a less secure part of the data management system 3. In step 109, asset status information ASI is generated for one or more of the assets having an asset identifier stored in first data storage 31. The asset status information ASI may be provided by the user of the system, and may be updated by the user from time to time, and/or may be updated by the data management system based on the usage history of the assets used with the system. The asset status information ASI may be stored in the first data storage 31, or may be stored elsewhere.

In FIG. 8 a flow chart is shown of an exemplary method performed in a data management system 3, 3a, 3b for handling asset identifiers AIDs of assets 2. The steps in the left column of FIG. 7 may be performed in a less secure part of the data management system 3. The steps in the right column of FIG. 7 are preferably performed in a secured part of the data management system 3.

An asset code CID and group code GC may be received from an asset by the data management system 3, e.g. via the authentication service shown in FIG. 1. The asset code CID may be verified by checking the asset code CID against the stored asset identifiers AIDs in the first data storage 31. Hereto a request of the validity of the asset code CID for the received group code GC may be transmitted to a secured part of the data management system 3.

In step 104 the cryptographic key K associated with the group code GC of the asset may be retrieved from the second data storage 32. In step 103 a mathematical operation 8-1 may be performed on the asset code CID to derive the corresponding asset identifier AID. This is depicted as AID=ε−1(CID). The mathematical operation may use the cryptographic key K, for example as a cryptographic decryption key in an AES-based cryptographic mathematical operation.

In step 105 the thus obtained asset identifier AID may be verified against the stored asset identifiers AID to determine its authenticity. In this way, the identity and authenticity of the asset code CID may be verified. The result of the verification may be output as a verification result V.

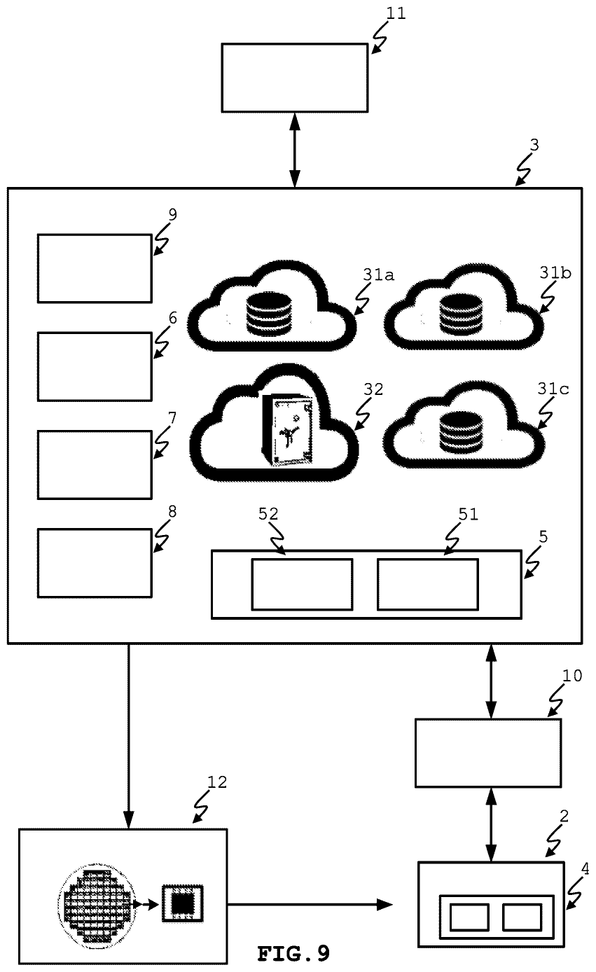

FIG. 9 shows a simplified schematic diagram of an exemplary data management system 3. The system 3 is used with a plurality of assets 2, each asset containing an integrated circuit 4 embedded with an asset code CID and a group code GC.

The data management system 3 includes the first data storage, in this embodiment comprising three separate databases 31a, 31b, 31c which may be stored on separate servers, which together the asset database storing asset identifiers AID for the assets 2. The first data storage 31 may also store status information ASI associated with each asset 2, and may also store the group codes GC. The second data storage 32 stores the cryptographic keys K for each group of assets, and may also store a group code GC for each group. The second data storage 32 is a secure data storage adapted to limit access to the stored data using a security protocol.

The system 3 also includes a communication module for communicating with the assets, including a receiving module 51 and transmitting module 52. The receiving module 51 is adapted to receive data for the assets, including a group code GC and an asset code CID from an asset 2. The transmitting module 52 is adapted to transmit verification results V to the assets 2.

A cryptographic module 6 communicates with the receiving module 51 and the second data storage 32, and adapted to derive an asset identifier AID corresponding to an asset code CID received from an asset 2, using a cryptographic key K obtained from the second data storage 32, where the cryptographic key K is associated with the group code GC also received from the first asset 2.

A verification module 7 communicates with the cryptographic module 6 and the first data storage 31, and is adapted to verify the status of the first asset 2. The verification module is adapted to determine if the asset identifier AID derived by the cryptographic module 6 matches an asset identifier AID stored in the first data storage 31, and to generate a verification result V based at least in part on the determination. The verification module 7 may also access the status information ASI associated with the asset 2 from the first data storage 31 if the first asset identifier AID matches an asset identifier AID stored in the first data storage 31, and generate a verification result V based at least in part on the accessed status information ASI.

In case an asset code CID and group code GC are used in a non-authorized combination, the system 3 may return a negative verification result indicative of a failed authentication. Alternatively or additionally, in case of a negative verification result the system 3 may block the asset code CID from any future use, resulting in future verification results for this asset code to be negative by default.

The system 3 may also include a database update module 9 which communicates with the receiving module 51 and the first data storage 31, and generates contextual data associated with each asset 2. The contextual data may include data relating to current and previous interactions with an asset, i.e. for a particular group code GC and/or asset code CID received from an asset. The contextual data may include one or more of: total number of the times a group code and/or an asset code is received from an asset, number of such receipts in a predefined time period, a frequency of such receipts, times of the receipts, and/or a location from where the receipts originate.

The contextual data may be stored in the database in the first data storage 31, indexed according to the relevant asset identifier for the asset. The verification module 7 may access the contextual data from the first data storage 31 for an asset, use the contextual data to generate a verification result V.

An asset terminal 10 may also be used with the system 3, to interact with the assets 2. An asset 2 may connect to the terminal 10, e.g. by a cable or wirelessly by Bluetooth or RFI interface, or the terminal 10 may scan the asset 2, in order to receive the group code GC and asset code CID from the asset 2. The terminal 10 then transmits the received group code GC and asset code CID to the receiving module 51 of the system 3, and terminal the receives the verification result V from the transmitting module 52 of the system 3. The verification result can then be displayed on the terminal. This arrangement reduces the need for the asset in include any facilities for communicating with the system 3, enabling the cost of adapting the assets for use with the system 3 to be further reduced.

A management terminal 11 may also be used with the system 3, to enable a system user to read, write, update and manage the asset information, such as the asset identifiers AID, asset status information ASI, contextual data of the assets, and group codes GC.

The cryptographic module 6 may also be adapted to generate one or more second cryptographic key K2 associated with one or more groups of assets. The second keys K2 may also be stored in the second data storage 32, and the system may use the second keys K2 to authenticate communications between the asset 2 and the system 3. The integrated circuit 4 in the assets 2 may additionally store an authentication value IH hard-coded into the integrated circuit, the authentication value being generated based on the second operator key K2.

The system 3 may also include a generation module 8 which communicates with the first data storage 31, and is adapted to generate an asset code CID corresponding to an asset identifier AID using a cryptographic key K associated with the group code GC of the corresponding asset identifier AID. An asset code CID may be generated before or during the production process of ICs 4. Asset codes CID generated from the asset identifiers AID may be transmitted to an IC manufacturing facility (foundry), for example in the form of GDSII files for manufacturing the IC 4.

Advantageously, in the data management system 3, most or all security may be focused on restricting access to a centralized “vault”, comprising the second data storage 32 and optionally also the cryptographic module 6. There may be multiple databases located at separate locations, which together comprise the first data storage 31. For example, each customer may maintain its own database of asset information (including the asset identifiers AIDs and asset status information ASI), and do not have to be concerned about providing security against unauthorized access to their asset database.

When an asset is checked, e.g. by connecting to or scanning by an asset terminal 10, the link between that asset and the asset database in the first data storage is made by securely accessing the second data storage 32. The response may be a verification result limited to a simple “Yes” (or other indication of a positive verification result) or “No” (or other indication of a negative verification result) as outcome.

The data management system 3 may take the context of verification requests into account in processing the current verification request. Examples hereof are a number of requests made in a predefined time interval, the total number of requests made, time of the request, location of the request, and etcetera. Contextual information may be transmitted as contextual data to data management system 3 and/or generated in the data management system 3. Part or all of the contextual data may be generated in the assets.

Hackers may want to try to replicate or falsify asset codes CID. However, duplication of an asset code CID may be detected by the system 3, and the asset identifier AID and thereby the asset code CID blocked for future use. Although asset codes CID can in principle be public, they may be encrypted during communication with the data management system 3. In other words, hacking an asset 2 or IC 4 does not make any sense, since all security processing takes place in the data management system 3. The IC 4 thus acts as a hardware anchor (e.g. to attach the asset code to the asset) in an otherwise centralized secure system 3. So, although the assets 2 and ICs 4 could be hacked (e.g. copied), the system remains secure.

Modifications to the embodiments described above may be made to the structures and techniques described herein without departing from the spirit and scope of the invention. Accordingly, although specific embodiments have been described, these are examples only and are not limiting upon the scope of the invention.

1. A data management system for managing data relating to assets, the assets arranged in one or more groups of assets, the system comprising:
a first data storage comprising an asset database storing an asset identifier for each asset;
a second data storage adapted to store a group code and a cryptographic key for each group of assets;
a receiving module adapted to receive a group code and an asset code from a first asset;
a cryptographic module communicatively coupled to the receiving module and the second data storage, and adapted to derive a first asset identifier corresponding to the asset code received from the first asset, using a cryptographic key obtained from the second data storage, the cryptographic key associated with the group code received from the first asset; and
a verification module communicatively coupled to the cryptographic module and the first data storage, and adapted to verify the status of the first asset, wherein the verification module is adapted to determine if the first asset identifier matches an asset identifier stored in the first data storage and generate a verification result based at least in part on the determination, and
wherein the first data storage additionally stores status information associated with each asset, and wherein the verification module is adapted to access the status information associated with the first asset from the first data storage if the first asset identifier matches an asset identifier stored in the first data storage, and generate a verification result based at least in part on the accessed status information.

2. The system according to claim 1, further comprising a database update module communicatively coupled to the receiving module and the first data storage, and adapted to generate contextual data associated with each asset, wherein the contextual data comprises data relating to current and previous receipts of a first group code and/or a first asset code by the receiving module, including one or more of: a total number of the receipts, a number of the receipts in a predefined time period, a frequency of the receipts, times of the receipts, and/or a location from where the receipts originate.

3. The system according to claim 1, wherein the first data storage is adapted to store the contextual data associated with each asset, and wherein the verification module is adapted to access the contextual data associated with the first asset from the first data storage if the first asset identifier matches an asset identifier stored in the first data storage, and generate a verification result based at least in part on the accessed contextual data.

4. The system according to claim 1, wherein the first asset is adapted to transmit the group code and asset code to the receiving module, and the system further comprises a transmitting module adapted to transmit the verification result to the first asset.

5. The system according to claim 1, further comprising an asset terminal, wherein the terminal is adapted to receive the group code and asset code from the first asset, and transmit the received group code and asset code to the receiving module, and the system further comprises a transmitting module adapted to transmit the verification result to the terminal.

6. The system according to claim 1, wherein the second data storage is a secure data storage adapted to limit access to the stored data using a security protocol.

7. The system according to claim 1, the database of the first data storage is adapted to store the group codes.

8. The system according to claim 1, further comprising a generation module communicatively coupled to the first data storage, and adapted to generate an asset code corresponding to an asset identifier using a cryptographic key associated with the group code of the corresponding asset identifier.

9. The system according to claim 1, wherein the asset comprises an integrated circuit having an asset code of the asset permanently hard-coded into the integrated circuit.

10. The system according to claim 1, wherein the asset comprises an integrated circuit having a group code and an asset code of the asset permanently hard-coded into the integrated circuit, and wherein the functionality of the integrated circuit is limited to providing the group code and the asset code upon request.

11. The system according to claim 1, wherein the cryptographic module is adapted to generate a second cryptographic key associated with one of the groups, the second data storage is adapted to store the second cryptographic key, and the system is adapted to use the second cryptographic key to authenticate communications between the asset and the transmitting module.

12. The system according to claim 11, wherein the asset comprises an integrated circuit having a group code, an asset code and an authentication value of the asset permanently hard-coded into the integrated circuit, wherein the authentication value is generated based on the second operator key.

13. The system according to claim 12, wherein the functionality of the integrated circuit is limited to providing the group code, the asset code, and the authentication value upon request, and receiving a challenge message from the transmitting module and transmitting a response based on the authentication value.

14. A method for managing data relating to assets, the assets arranged in one or more groups of assets, the method comprising:
assigning a group code to each group of assets;
generating an encryption key linked to the group code;
storing the group code and the encryption key in a second data storage; assigning an asset identifier to each asset in the group;
storing the group codes and the asset identifiers in a database in a first data storage;
receiving a group code and an asset code from a first asset; deriving a first asset identifier corresponding to the asset code received from the first asset, using a cryptographic key associated with the group code received from the first asset;
verifying the status of the first asset, comprising determining if the first asset identifier matches an asset identifier stored in the first data storage; and generating a verification result based at least in part on the determination.

15. The method according to claim 14, further comprising storing status information associated with each asset in the first data storage, wherein verifying the status of the first asset comprises accessing the status information associated with the first asset from the first data storage if the first asset identifier matches an asset identifier stored in the first data storage, and the verification result is based at least in part on the accessed status information.

16. The method according to claim 14, further comprising generating an asset code corresponding to an asset identifier using a cryptographic key associated with the group code of the corresponding asset identifier, and storing the generated group code and asset code in the asset corresponding asset identifier.
